(19) United States
(12) Patent Application Publication
(10) Pub. No.: US 2026/0119875 A1
(43) Pub. Date: Apr. 30, 2026

(54) GENERATING ENCODER MODEL(S) BASED ON PRE-TRAINED DECODER GENERATIVE MODEL(S)

(71) Applicant: GOOGLE LLC, Mountain View, CA (US)

(72) Inventors: Paul Suganthan G C, Zurich (CH); Zhe Dong, Zurich (CH); Fedor Moiseev, Zurich (CH); Jianmo Ni, Santa Clara, CA (US); Le Yan, San Jose, CA (US); Junru Wu, Jersey City, NJ (US); Jay Han, Saratoga, CA (US); Xuanhui Wang, Cupertino, CA (US)

(21) Appl. No.: 19/349,683

(22) Filed: Oct. 3, 2025

Related U.S. Application Data
(60) Provisional application No. 63/712,022, filed on Oct. 25, 2024.
(60) Provisional application No. 63/725,922, filed on Nov. 27, 2024.

(51) Int. Cl. G06N 3/082

(52) U.S. Cl. CPC G06N 3/082

(57) ABSTRACT

Various implementations include generating an encoder-only model based on initializing one or more weights of one or more attention layers of the encoder-only model using one or more corresponding weights of one or more corresponding attention layers of a decoder-only generative model. Other implementations may be described and/or claimed.

### BACKGROUND

Various generative models, e.g., large language models (LLMs), have been proposed to generate output that reflects generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. As one example, many generative models use a decoder-only architecture (e.g., a decoder-only transformer). However, decoder-only models may not perform well with some non-generative tasks, such as classification, regression, and ranking.

### SUMMARY

Generally, decoder-only models may have limited applicability for tasks such as classification tasks, regression tasks, ranking tasks, additional or alternative encoding based tasks, and/or combinations thereof. In contrast, encoding-only models may generally perform well on tasks such as classification tasks, regression tasks, ranking tasks, additional or alternative encoding based tasks, and/or combinations thereof.

Generally, encoding-only models are often randomly initialized. As used herein, random initialization may refer to the assignment of random, non-zero initial values to weights and biases of the model. Randomly initialized encoder-only models may require a significant amount of training (and a corresponding significant utilization of computing resources) to achieve desired accuracy and/or robustness.

Implementations herein may resolve one or more of the above-described issues related to random initialization of an encoder-only model by initializing weights of the encoder-only model (e.g., the weights of one or more attention layers of the encoder-only model) based on weights of the decoder-only generative model. Implementations can provide significant technical benefits from the standpoint of enabling robust and/or accurate performance of tasks with lesser amounts of training. For example, initializing with such weights may enable leveraging of existing semantic understanding capabilities of the pre-trained decoder-only model (e.g., multimodal understanding capabilities such as language understanding capabilities).

In other words, initializing the encoder-only model with weights based on weights of a pre-trained decoder-only generative model and performing a given amount of training for an encoding task can result in an encoder-only model that has an increased measure of robustness and/or an increased measure of accuracy for the encoding task. This increased measure of robustness and/or increased measure of accuracy for the encoding task may be considered to be an improvement as compared to robustness and/or accuracy of the encoder-only model when the encoder-only model is not initialized with weights of the pre-trained decoder-only generative model (e.g., the weights are randomly initialized).

As an example, in some of implementations, the weights of one or more layers of the encoder-only model can be based on the weights of one or more corresponding layers of the decoder-only generative model. For example, the weights of one or more attention layers of the pre-trained decoder-only generative model can be used to initialize the weights of one or more corresponding attention layers of the encoder-only model. After initialization, the encoder-only model can be trained for a variety of encoding tasks including classification, regression, ranking, etc.

Additional or alternative adaptations can be made to the encoder-only model to increase accuracy and/or robustness of the performance of encoding tasks. For example, causal attention used in the decoder-only generative model can be adapted to bidirectional attention in the encoder-only model (e.g., adapting the encoder-only model for bidirectional attention through finetuning on downstream task(s)). As used herein, causal attention may refer to a mechanism in generative models that ensures the model can only attend to past and present tokens in a sequence, not future ones. Generally, causal attention may prevent the model from “cheating” by seeing the correct answer during training, forcing it to generate text one token at a time based only on what it has already produced. By contrast, bidirectional attention can refer to a mechanism that allows a model to consider the entire input sequence when processing a specific token, looking at both the preceding and succeeding words. Unlike causal attention, which only looks backward, bidirectional attention can provide a complete contextual understanding of each token, thereby making it useful for tasks like text classification and question answering where full context is useful.

Similarly, one or more pooling layers can be added to the encoder-only model. As used herein, a “pooling layer” can refer to a layer in a neural network that is used to downsample the output of a convolutional layer, reducing the spatial dimensions of the feature maps. This process can help to decrease the computational load and extract the most salient features, making the model more efficient and robust to variations in the input data. Generally, an encoder-only model architecture without pooling may process the final hidden state of each of the tokens in the sequence. In some implementations, a variety of pooling layers can be integrated with the encoder-only model architecture including mean pooling, attention pooling, last token pooling, additional or alternative types of pooling, and/or combinations thereof. In some implementations, mean pooling can include averaging the hidden states across each of the tokens in the sequence. Additionally or alternatively, attention pooling can use an attention mechanism to weight and aggregate token representations. Furthermore, last token pooling can use the hidden state of the final token in the sequence.

Furthermore, fine-tuning of the encoder-only model can include dropout (when dropout was not used while training the pre-trained decoding-only generative model). Dropout is not commonly used in pretraining of generative models, such as the decoder-only generative model. However, dropout can significantly boost the encoder-only model robustness in finetuning the encoder-only model for one or more encoder tasks. As used herein, the term “dropout” can refer to a regularization technique that randomly and temporarily sets a portion of the neurons in a neural network to zero during the training process. This technique can force the model to learn more robust features and prevent it from becoming overly reliant on any single neuron, thereby reducing the risk of overfitting (e.g., over-reliance on one or more data points which can reduce the model's ability to generalize to new data or inputs).

In some implementations, as noted, the decoder-only model may use causal attention. For example, the decoder-only model can process a sequence of tokens and generate an attention score for a given token based on the relationship between the given token and one or more additional tokens in the sequence. As previously noted, with causal attention, an attention score for a given token in the sequence may be based on the relationship between the given token and one or more previous tokens in the sequence. In other words, the attention scores may be generated without looking forward in the sequence of tokens. However, encoding tasks (e.g., classification, regression, ranking, etc.) may benefit from knowledge of the given token's relationship with each of the tokens in the sequence including one or more previous tokens and/or one or more subsequent tokens. As such, in some implementations, after initialization of the weights based on the decoder-only generative model, one or more layers of the encoder-only model can be adapted for bidirectional attention. Adapting one or more layers of the encoder-only model may allow the encoder-only model to retain the existing language understanding capabilities of the decoder-only generative model while also gaining additional knowledge in the form of bidirectional attention scores, which may be helpful in encoding tasks.

Accordingly, various implementations are directed towards initializing weights of one or more attention layers of an encoder-only model based on corresponding weights of one or more corresponding attention layers of a decoder-only generative model. Initializing the weights of the encoder-only model may enable the encoder-only model to leverage the natural language understanding of the pre-trained decoder-only generative model. In contrast, training the encoder-only model without initializing the weights based on the decoder-only generative model (e.g., randomly initializing the weights, etc.) may require more computing resources (e.g., time, processor cycles, memory, power, etc.) to train a robust encoder-only model compared to training the encoder-only model with the weights initialized based on the decoder-only generative model.

In some implementations, decoder-only generative model pretraining may include processing token level input, while the encoder-only model generally processes a more robust input signal (e.g., a paragraph, an entire document, etc.). Accordingly, initializing the encoder-only model based on the decoder-only generative model can provide the encoder-only model with a more robust semantic understanding foundation, which can increase the robustness of the encoder-only model when processing out-of-distribution data.

In some specific implementations, semantic understanding capabilities from the decoder-only generative model can be lost when updating the weights of the encoder-only model (e.g., the weights of the one or more attention layers of the encoder-only model initialized based on corresponding weights of the decoder-only generative model). For example, some decoder-only generative models may have multimodal semantic understanding capabilities, where different modalities of input data map to a shared embedding space. For example, a text embedder can map text input to the shared embedding space; an audio embedder can map audio data input to the shared embedding space; and a vision embedder can map vision data input into the shared embedding space. This multimodal semantic understanding from the decoder-only generative model may be lost when the corresponding weights of the encoder-only model are updated.

In some implementations, this multimodal semantic understanding transferred from the decoder-only generative model can be preserved in the encoder-only model by setting one or more frozen weights of the encoder-only model based on the corresponding weights of the set of attention layers of the decoder-only generative model. In some implementations, the encoder-only model can be trained for one or more encoding tasks based on updating one or more trainable layer weights and updating one or more pooling layers while leaving the one or more weights of the set of attention layers frozen. By freezing those weights of the set of attention layers in the encoder-only model and training one or more trainable layer weights and one or more pooling layers for the encoding task, multimodal semantic understanding that would be lost by training the weights of the set of attention layers is preserved in the encoder-only model.

For instance, setting frozen weights of the encoder-only model (i.e., frozen weights of a set of attention layers) based on corresponding weights of the decoder-only generative model and performing a given amount of training for an encoding task can result in an encoder-only model that has an increased measure of robustness and/or an increased measure of accuracy for the encoding task, where training the encoder-only model for the encoding task is limited to training one or more trainable layer weights and/or one or more pooling layers of the encoder-only model and does not include training the frozen weights of the set of attention layers. The increased measure of robustness and/or the increased measure of accuracy for the encoding task may be an improvement compared to robustness and/or accuracy for the encoding task when the weights of the set of attention layers of the encoder-model are updated during training for the encoding task and are not frozen.

Similarly to previously-described example implementations, the encoder-only model can be generated based in part on a pre-trained decoder-only generative model such that weights of one or more layers of the encoder-only model can be based on the weights of one or more corresponding layers of the decoder-only generative model. However, in some implementations, the weights of one or more attention layers of the pre-trained decoder-only generative model can be used to set the frozen weights of the corresponding set of attention layers of the encoder-only model. After setting the frozen weights, one or more trainable layer weights and/or one or more pooling layers of the encoder-only model can be trained for a variety of encoding tasks including classification, regression, ranking, retrieval, embedding, etc.

In some implementations, the encoder-only model architecture can be adapted for encoding tasks by training one or more layer weights, where each attention layer, in the set of attention layers, has a corresponding trainable layer weight. In some versions of those implementations, the learnable layer weights can be used to combine the per-layer activations. In the decoder-only generative model, the last layers may typically be trained for decoding tasks, such as next token prediction, and are not useful for encoding tasks (e.g., tasks requiring summarization of an entire sequence). In some implementations, the activation weights of the inner layers of the encoder-only model can be weighed more heavily than the activation weights of the last layers of the encoder-only model, which can allow the encoder-only model to be fine-tuned for the encoding task while preserving the multimodal semantic understanding of the decoder-only generative model.

Additionally or alternatively, training one or more pooling layers of the encoder-only model with frozen weights (i.e., with frozen weights set based on the corresponding weights of the decoder-only generative model) for the encoding-only task can increase the accuracy and/or robustness of the encoder-only model as previously described. For example, as previously described with respect to other implementations, a variety of pooling layers can be integrated with the encoder-only model architecture including mean pooling, attention pooling, last token pooling, additional or alternative types of pooling, and/or combinations thereof.

Accordingly, some implementations herein may be directed towards setting frozen weights of the set of attention layers of an encoder-only model based on corresponding weights of a set of corresponding attention layers of a decoder-only generative model. Setting the frozen weights of the encoder-only model may enable the encoder-only model to leverage the natural language understanding of the pre-trained decoder-only generative model. In contrast, training the encoder-only model without setting the weights based on the decoder-only generative model (e.g., randomly initializing the weights, etc.) may require more computing resources (e.g., time, processor cycles, memory, power, etc.) to train a robust encoder-only model compared to training the encoder-only model with the weights initialized based on the decoder-only generative model. Furthermore, by freezing the weights of the set of attention layers of the encoder-only model and training a set of trainable layer weights and/or one or more pooling layers, multimodal semantic understanding capabilities of the decoder-only generative model can be preserved in the encoder-only model.

As a non-limiting example of some implementations disclosed herein, a system can generate a specialized text classification encoder model from a large, pre-trained multimodal decoder-only generative model. The decoder model, initially trained on vast amounts of text and images, may use causal attention for text generation. To create the encoder, the weights from the decoder's attention layers may be copied to initialize the corresponding layers of the new encoder model. This new encoder model may then be adapted for bidirectional attention, allowing it to consider the full context of a sentence. Finally, the encoder model may be fine-tuned on a specific task, such as sentiment analysis of customer reviews. During this fine-tuning, the initialized attention layers might be updated, or new output and pooling layers are added and trained, enabling the final encoder model to accurately classify the sentiment of a review by leveraging the deep language understanding inherited from the original decoder model.

As another example, consider a healthcare system aiming to create an encoder model for classifying medical images, such as X-rays, into categories like “pneumonia,” “normal,” or “other anomaly.” The system starts with a powerful, pre-trained multimodal decoder-only model, which understands both text (from medical reports) and images. The weights of this decoder's attention layers are copied to a new encoder-only model to provide a strong foundation in visual and contextual understanding. However, to preserve the nuanced multimodal knowledge gained from the vast pre-training data, these initialized attention layer weights are frozen and not updated during subsequent training. Instead, only new pooling layers and a final classification layer are trained on a specific, labeled dataset of X-ray images. This approach may allow the new encoder to specialize in the X-ray classification task while retaining the robust, general-purpose feature extraction capabilities of the original decoder, leading to higher accuracy and better generalization, especially with limited medical training data.

Some implementations herein may be described with respect to generative models. As used herein, a “generative model” may be or refer to a computational model capable of generating new data that resembles the data on which it was trained. For example, a generative model may be used to generate various types of content, such as text, images, audio, or video. One specific type of generative model is a Large Language Model (LLM), which can be used to generate text-based content. It will be recognized, however, that such description of a generative model is used herein for the sake of example only, and in other implementations a different type of model may be additionally or alternatively used. For example, a neural network, a support vector machine (SVM), a decision tree, or a random forest could be additionally or alternatively used.

In some descriptions or discussions herein, a generative model may be anthropomorphized such that it is described as performing an action such as “processing,” “learning,” “advancing,” etc. It will be understood that such description is intended in the broad sense in a manner that is consistent with the technology and common usage in the art. For example, a generative model may be described as “generating” an element such as an electronic flash card, identifying one or more data sources, identifying or partitioning one or more information elements, etc. It will be understood that such description may more accurately be stated as an electronic device may, through a combination of hardware, software, and/or firmware, implement an AI engine. The AI engine may, in accordance with one or more instructions, perform one or more of the described actions using a set of data that makes up a generative model to generate the described output.

It will be understood that this summary, and the subsequent detailed description, are presented herein for the sake of providing examples of various implementations and processes that can be implemented. However, it will be understood that these examples are non-limiting and are presented for illustrative purposes only. The particular number, arrangement, or naming of various elements within the accompanying Figures are intended for discussion of various concepts, and one or more of the elements and/or Figures could be significantly altered in other implementations. For instance, in Figures related to particular structures and/or Figures related to process flows or techniques, several elements can be combined into a singular, integrated component, or a single element can be subdivided into multiple discrete elements to perform more granular functions. Furthermore, any described method or system can be modified by adding, removing, or rearranging steps or components, or by combining aspects of different examples, without departing from the broader scope of the concepts described herein. The features, structures, and functionalities described are not limited to the specific examples provided and can be applied in numerous alternative forms and contexts.

### BRIEF DESCRIPTION OF THE DRAWINGS

FIG. 1A illustrates an example encoder-only model architecture in accordance with various implementations.

FIG. 1B illustrates another example of an encoder-only model architecture in accordance with various implementations.

FIG. 2A illustrates another example encoder-only model architecture in accordance with various implementations.

FIG. 2B illustrates another example of an encoder-only model architecture in accordance with various implementations.

FIG. 3 illustrates a flowchart depicting an example process in accordance with various implementations.

FIG. 4 illustrates a flowchart depicting another example process in accordance with various implementations.

FIG. 5 illustrates a flowchart depicting another example process in accordance with various implementations.

FIG. 6 illustrates an example environment in which various implementations disclosed herein may be implemented.

FIG. 7 illustrates an example architecture of a computing device.

### DETAILED DESCRIPTION

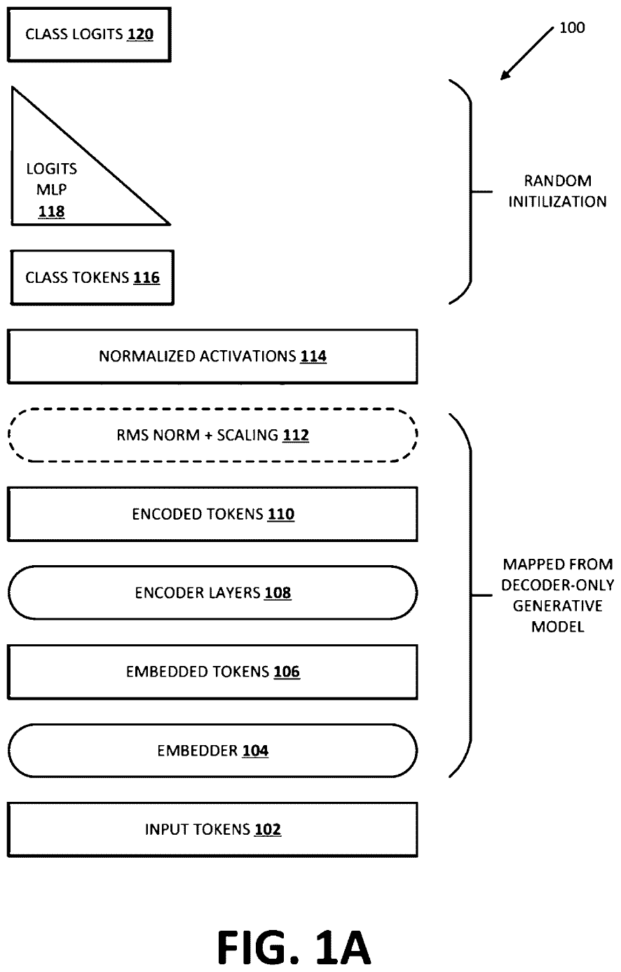

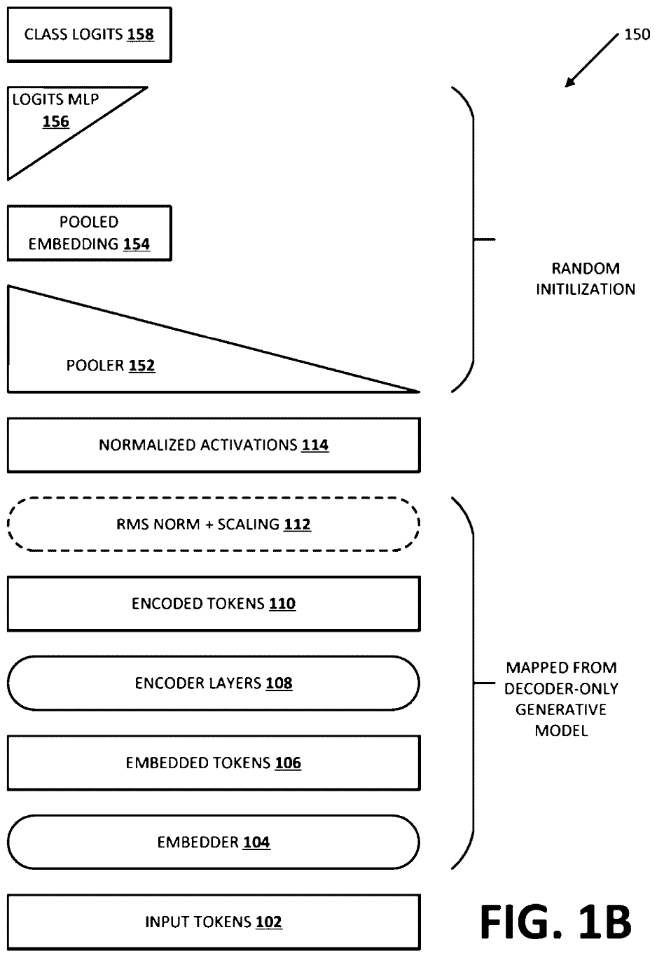

Turning now to the figures, FIG. 1A and FIG. 1B illustrate examples of encoder-only model architecture in accordance with various implementations. Example architecture 100 of FIG. 1A illustrates an encoder-only model without pooling layers. Example architecture 150 of FIG. 1B illustrates an encoder-only model with one or more pooling layers. Illustrated examples 100 and 150 depict a particular model architecture of a decoder-only transformer model. However, this is not meant to be limiting. Additional or alternative model architectures may be used in accordance with various implementations.

Example 100 may include input tokens 102 which can be processed using embedder 104 to generate embedded tokens 106. As used herein, the term “embedded tokens” may refer to tokens that comprises a numerical representation of input tokens that capture their semantic meaning in a high-dimensional vector space. In some implementations, one or more encoder layers 108 can process the embedded tokens 106 to generate encoded tokens 110. As used herein, the term “encoded tokens” may refer to representations of input tokens, usually consisting of n-dimensional vectors, that are suitable for subsequent neural network processing and/or classification. The system can optionally process the encoded tokens 110 using root mean squared normalization+scaling 112 to generate normalized activations 114. As used herein, “normalized activations” may refer to normalized feature vectors. Additionally or alternatively, class tokens 116 can be generated based on the normalized activations 114. As used herein, the term “class token” may refer to a feature vector that represents the likelihood that an input token belongs to a given class of items in a classification task. The class tokens 116 can, in some implementations, be processed using one or more logits multilayer perceptrons (MLPs) to generate class logits 120. As used herein, a “logit” may refer to a representation of a probability distribution. In some implementations, output of the encoding task can be generated based on the class logits 120.

In the illustrated example 100, one or more portions of the encoder-only model can be mapped from the decoder-only generative model. For example, weights corresponding to the embedder 104 and/or the encoder layers 108 can be mapped from the decoder-only generative model. Additionally or alternatively, the structure of embedded tokens 106, encoded tokens 110, and/or the root mean squared+scaling 112 can be mapped from the decoder-only generative model. In some implementations, the logits MLPs 118 may not be used as components in the decoder-only generative model, and the logits MLPs 118 can be tailored for one or more encoding tasks.

Example architecture 150 as illustrated in FIG. 1B may include input tokens 102, embedder 104, embedded tokens 106, encoder layers 108, encoded tokens 110, optional root mean squared normalization+scaling 112, and normalized activations 114 as described above with respect to FIG. 1A. However, example architecture 150 may further include one or more pooling layers. In some implementations, normalized activations 114 can be processed using pooler 152 to generate pooled embeddings 154. As used herein, the term “pooled embeddings” may refer to a concatenated embedding of pooled activations. In some implementations, the pooled embeddings 154 can be processed using the logits multilayer perceptrons 156 to generate class logits 158. In some of those implementations, encoding output can be generated based on class logits 158.

The encoder-only model can include a variety of types of pooling (e.g., pooler 152) such as mean pooling, attention pooling, last token pooling, additional or alternative pooling techniques, and/or combinations thereof. In mean pooling, the hidden states across all tokens can be averaged. In attention pooling, an attention mechanism can be used to weight and aggregate token representations. In last token pooling, the hidden state of the final token can be used in pooling.

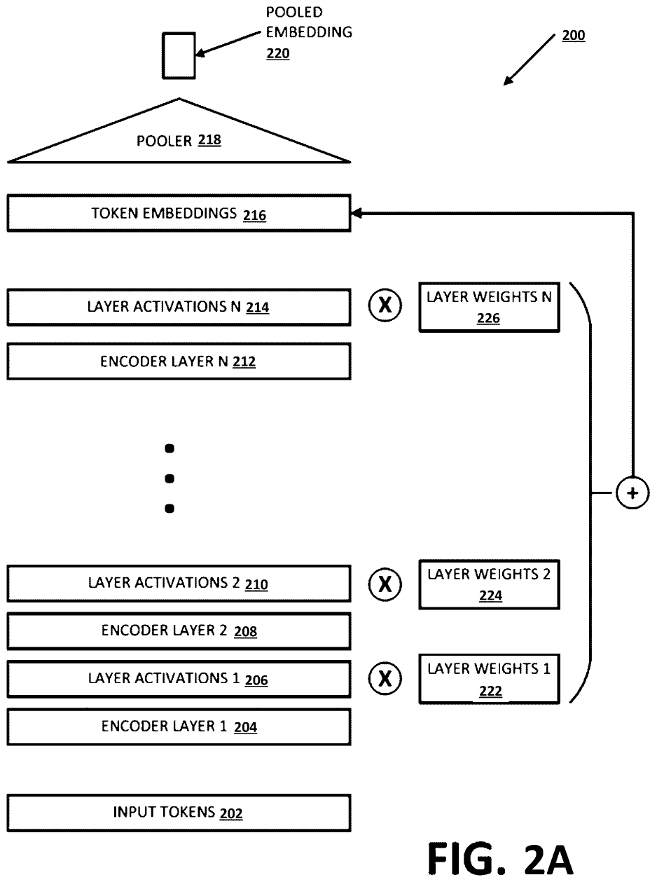

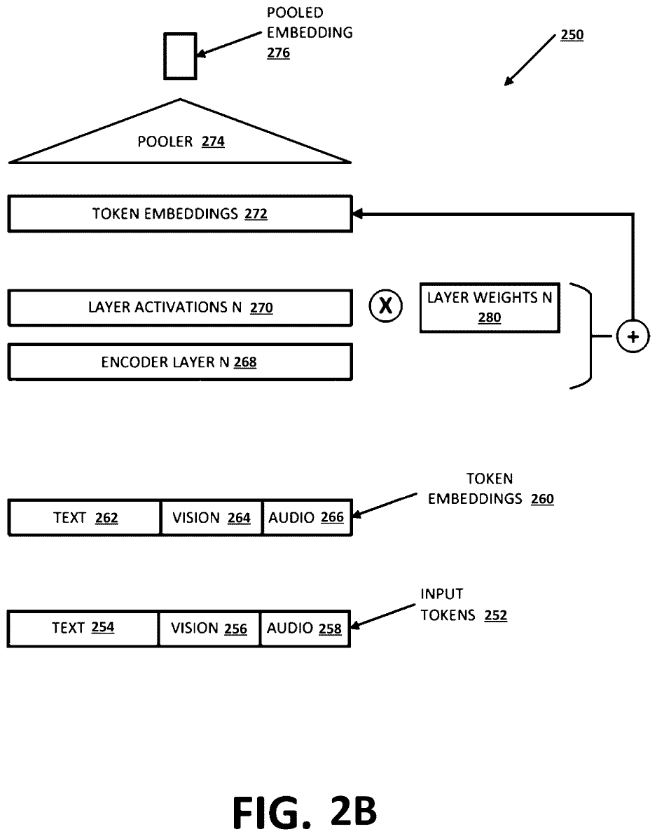

FIGS. 2A and 2B illustrate alternative examples of encoder-only model architectures in accordance with various implementations. Example architecture 200 of FIG. 2A may illustrate an encoder-only model with a set of trainable layer weights and one or more pooling layers. FIG. 2B may illustrate an encoder-only model with a set of trainable layer weights, one or more pooling layers, and multimodal input. Illustrated examples 200 and 250 may be considered to depict a particular model architecture of an encoder-only transformer model. However, as previously described, such depiction is not meant to be limiting to the particular depicted embodiment(s). Additional or alternative model architectures may be used in accordance with various implementations.

Example 200 may include input tokens 202 which may be processed using one or more encoder layers and corresponding layer activations set based on a decoder-only generative model. For example, encoder-only model 200 can include encoder layer 1 204 and corresponding layer activations 1 206; encoder layer 2 208 and corresponding layer activations 2 210; and encoder layer N 212 and corresponding layer activations N 214. However, some implementations can include additional and/or alternative layers set based on a corresponding decoder-only generative model. As used herein, a “layer activation” may refer to a numerical representation of a layer weight (e.g., a weight of encoder layer 1 204, a weight of encoder layer 2 208, a weight of encoder layer N 212, etc.).

In some implementations, the layer activations (e.g., layer activations 1 206, layer activations 2 210, layer activations N 214, etc.) may be frozen to preserve semantic understanding (e.g., multimodal semantic understanding) from the decoder-only generative model. The encoder-only model can be trained for an encoding task based on training one or more trainable layer weights to generate a set of token embeddings 216. The token embeddings 216 can be processed using one or more trainable pooler layers 218 to generate pooled embedding output 220. As an example, in some implementations, each encoder layer and corresponding set of layer activations can have a set of corresponding layer weights. For example, layer weights 1 222 can be trained based on layer activations 1 206; layer weights 2 224 can be trained based on layer activations 2 210; layer weights N 226 can be trained based on layer activations N 214; etc.

In some implementations, the layer weights can be combined to generate the set of token embeddings 216. For example, layer weights 1 222, layer weights 2 224, and layer weights N 226 can be combined to generate token embeddings 216. As previously described, in some implementations the encoder-only model can include a variety of types of pooling (e.g., pooler 218) such as mean pooling, attention pooling, last token pooling, additional or alternative pooling techniques, and/or combinations thereof.

Example architecture 250 as illustrated in FIG. 2B may include input tokens 252. Input tokens 252 can include text data based input tokens 254, vision data based input tokens 256, audio data based input tokens 258, etc. In some implementations, each multimodal data type can be processed by a corresponding embedder (not depicted) to generate token embeddings 260, where each modality of input tokens maps to a shared embedding space. In other words, text based token embeddings 262, vision data based token embeddings 264, and audio data based token embeddings 266 map to the same shared embedding space.

Similar to the encoder layers and corresponding layer activations described with respect to encoder-only model 200, encoder-only model 250 may include one or more encoder layers and layer activations depicted as encoder layer N 268 and layer activations N 270. As described herein with respect to FIG. 2A, the encoder-only model 250 can be trained for an encoding task based on training one or more corresponding trainable layer weights (e.g., layer weights N 280 which corresponds with encoder layer N 268 and layer activations N 270) to generate a set of token embeddings 272. The token embeddings 272 can be processed using one or more trainable pooler layers 274 to generate pooled embedding output 276.

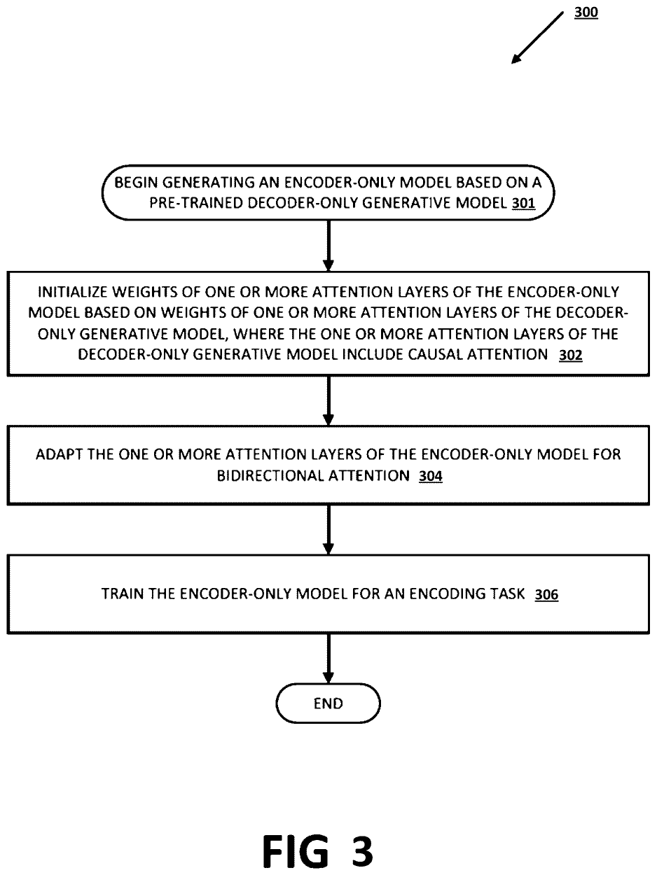

FIG. 3 is a flowchart illustrating an example process 300, in accordance with various implementations described herein. For convenience, the operations of the process 300 may be described with reference to a system that performs the operations. This system may include various components of various computer systems, such as one or more components of computing device 602 and/or computing system 710. Moreover, while operations of process 300 are shown in a particular order, such depiction is not meant to be limiting. One or more depicted operations of the process 300, and/or additional or alternative operations, may be reordered, omitted, or added in various other implementations.

As shown, the system may generate, at 301, an encoder-only model based on a pre-trained decoder-only generative model. In some implementations, the encoder-only model may be an encoder-only transformer model, and the decoder-only model is a decoder-only generative model. However, additional or alternative encoder-only and decoder-only models can be utilized in accordance with various implementations.

At block 302, the system may initialize weights of one or more layers (e.g., attention layers) of the encoder-only model based on weights of one or more corresponding layers (e.g., attention layers) of the decoder-only generative model. Initializing weights of the encoder-only model based on the decoder-only model may enable leveraging of existing language understanding capabilities of the pre-trained decoder-only model. In some implementations, the one or more attention layers of the decoder-only generative model, or functions of said attention layers of the decoder-only generative model, may include or relate to causal attention. As previously noted, causal attention may be a term that relates to a relationship between a given token in a sequence and each of the previous tokens in the sequence.

At block 304, the system may adapt the one or more attention layers of the encoder-only model for bidirectional attention. As previously noted, in contrast to decoding tasks which may rely on causal attention, encoding tasks (e.g., classification tasks, regression tasks, ranking tasks, etc.) may benefit from knowledge about the entire sequence of tokens (e.g., past and future tokens). Adapting attention layers encoder-only model for bidirectional attention can adapt the encoder-only model for encoding tasks while continuing to leverage the language understanding from the pre-trained decoder-model.

At block 306, the system may train the encoder-only model for an encoding task. For example, the encoder-only model can be trained for a named entity recognition task (e.g., a type of classification task). In some of those implementations, the encoder-only model may process input based on natural language input provided by a user to generate encoder output that indicates whether a named entity is recognized in the natural language input.

Additionally or alternatively, in some implementations it may be recognized that legacy decoder-only generative models will often forgo dropout during pre-training of the decoder-only model. However, dropout during fine-tuning of the encoder-only model can enhance the encoder-only model's performance on encoding tasks. As such, in some implementations, dropout can be used during fine-tuning of the encoder-only model for the one or more encoding tasks.

As a first real-world example of process 300, consider an online retailer seeking to improve its product recommendation system. The retailer may have a powerful, pre-trained decoder-only LLM used for generating product descriptions. Following the process 300 of FIG. 3, the retailer may first generate (301) a new encoder-only model for a classification task: predicting which product category a user's query belongs to. At 302, the weights of the new encoder's attention layers (e.g., encoder layers 108 in FIGS. 1A and 1B) may be initialized with the corresponding weights from the pre-trained decoder model. This initialization may serve to transfer the decoder model's nuanced understanding of product-related language. At 304, the causal attention mechanism from the decoder model may be adapted to bidirectional attention, allowing the encoder to analyze a user's entire query (e.g., “blue running shoes for men”) for context. Finally, at 306, the new encoder model may be trained on a dataset of user queries and their corresponding product categories. This training may fine-tunes the model for the specific classification task. As shown in FIG. 1B, this training may also involve adding and training a pooler 152 and/or logits MLP 156 to produce the final classification output (class logits 158), resulting in a highly accurate query-to-category classifier.

As a second real-world example, a company may wish to build a sentiment analysis model to classify customer support emails as “positive,” “negative,” or “neutral.” The company may begin (301) by leveraging a pre-existing, large decoder-only generative model that excels at understanding and generating human-like text. Following block 302 of process 300, the weights from the decoder's attention layers may be copied to initialize the attention layers (e.g., encoder layers 108) of a new encoder-only model, as illustrated in FIG. 1A. This element of the process may give the new encoder a significant head start in language comprehension. Next, per block 304, the attention mechanism may be adapted from causal to bidirectional to enable the model to consider the full context of each email. At block 306, the encoder-only model may be fine-tuned for the sentiment classification task using a labeled dataset of support emails. During this training, randomly initialized output layers (e.g., logits MLP 118) may be trained to map the encoder's output to the defined sentiment classes (e.g., class logits 120). The resulting model can accurately classify incoming support emails, leveraging the deep linguistic knowledge inherited from the original decoder.

As may be recognized by one of skill in the art, the above-described process 300 may provide significant benefits and advantages from both a technical perspective and a user experience perspective. For example, from a technical standpoint, this process 300 may significantly enhance computational efficiency. By initializing the encoder with the weights of a pre-trained decoder, the system may start with a sophisticated understanding of language, dramatically reducing the amount of data and processing power needed for training. This warm start, combined with adapting the model for bidirectional attention, may allow the system to converge on a high-performance solution for encoding tasks much faster than a randomly initialized model, thereby conserving time, energy, and financial resources. For the user, the system may be seen to provide more accurate and responsive applications. Whether classifying sentiment, recognizing named entities, or categorizing content, use of the resulting encoder model may perform with greater precision than may be experienced using legacy models. This improved performance may lead to a better user experience, with more relevant search results, smarter virtual assistants, and more reliable content filtering, all of which may be delivered faster and more consistently.

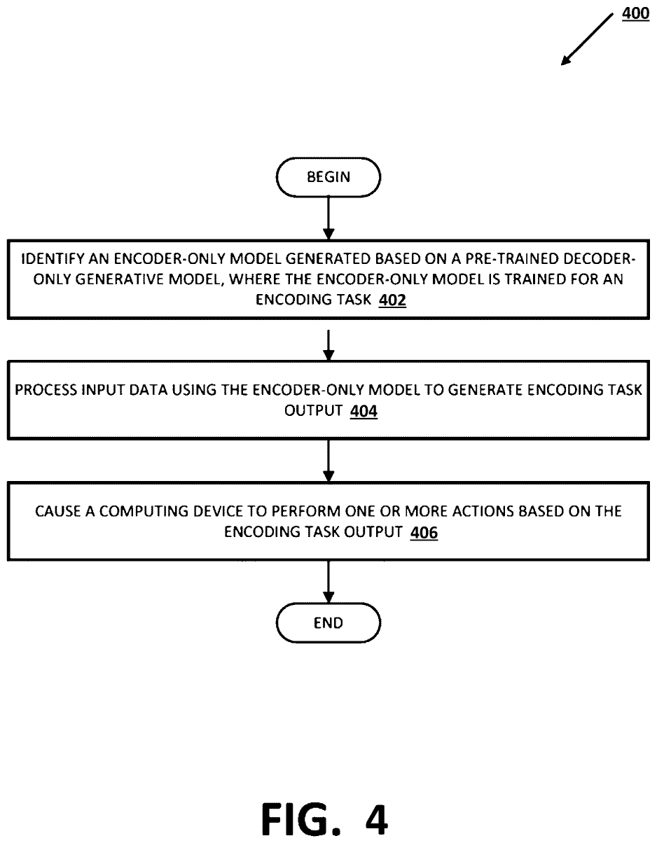

FIG. 4 is a flowchart illustrating an alternative example process 400 in accordance with various implementations described herein. For convenience, the operations of the process 400 may also be described with reference to a system that performs the operations. This system may include various components of various computer systems, such as one or more components of computing device 602 and/or computing system 710. Moreover, while operations of process 400 are shown in a particular order, such depiction is not meant to be limiting. One or more depicted operations of the process 400, and/or additional or alternative operations, may be reordered, omitted, or added in various other implementations.

At block 402, the system may identify an encoder-only model that was previously generated based on a pre-trained decoder-only generative model. In some implementations, the encoder-only model may be trained for an encoding task. For example, the system may identify and/or use an encoder-only transformer model that was generated based on a pre-trained decoder-only transformer generative model. In some implementations, the system may use or identify an encoder-only model that was generated in accordance with process 300 described herein with respect to FIG. 3, above.

At block 404, the system may process input data using the encoder-only model to generate encoding task output. For example, the system may process an image of a handwritten address using an encoder-only model trained for optical character recognition (a classification task). The system would be configured to use the model to generate text output transcribing the address from the image. At block 406, the system could then be configured to cause a computing device (which may be the same as, or different from, the same computing device or system that is performing one or more of the elements of FIG. 3 or 4) to perform one or more actions based on the encoding task output.

As a particular example of process 400, the encoder-only model can be trained to perform a classification task such as named entity recognition. In some of those implementations, the user can provide natural language input of “Play music by Hypothetical Singer”. Based on processing “Play music by Hypothetical Singer”, the system, using the encoder-only model, can generate output indicating ‘Hypothetical Singer’ is a named entity. Additionally or alternatively, the system can begin playing music by ‘Hypothetical Singer’ based in part on the named entity recognition task performed using the encoder-only model.

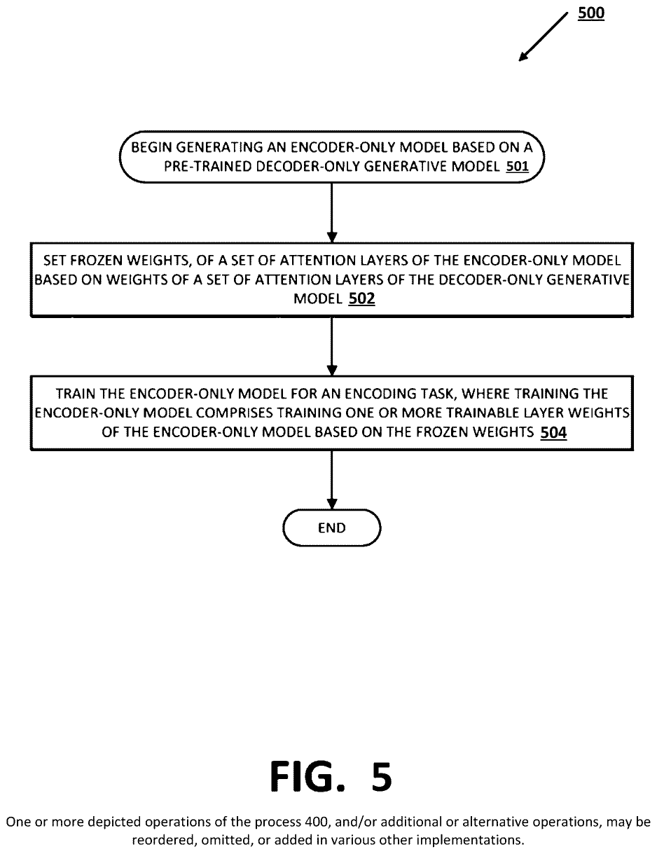

FIG. 5 is a flowchart illustrating another example process 500 in accordance with various implementations described herein. For convenience, the operations of the process 500 are described with reference to a system that performs the operations. This system may include various components of various computer systems, such as one or more components of computing device 602 and/or computing system 710. Moreover, while operations of process 500 are shown in a particular order, such depiction is not intended to limit other implementations to the depicted order. One or more depicted operations of the process 500, and/or additional or alternative operations, may be reordered, omitted, or added in various other implementations.

The system may begin by generating, at block 501, an encoder-only model based on a pre-trained decoder-only generative model. In some implementations, the encoder-only model may be an encoder-only transformer model, and the decoder-only model is a decoder-only generative model. However, additional or alternative encoder-only and decoder-only models can be utilized in accordance with various implementations.

At block 502, the system may set frozen weights of one or more layers (e.g., attention layers) of the encoder-only model based on weights of one or more layers (e.g., attention layers) of the decoder-only generative model. Setting the frozen weights of the encoder-only model based on the decoder-only model may enable various benefits. For example, the use of frozen weights of the encoder-only model may enable the encoder-only model to leverage an existing functionality of the decoder-only model. For example, if the decoder-only model is able to understand a variety of different languages, then freezing certain weights may allow the encoder-only model to leverage and/or incorporate those existing language understanding capabilities of the pre-trained decoder-only model.

At block 504, the system may train the encoder-only model for an encoding task (e.g., a classification task, a regression task, a ranking task, a retrieval task, an embedding task, one or more additional or alternative encoding tasks, and/or combinations thereof). In some implementations, only a set of layer weights and one or more pooling layers of the encoder-only model may be updated during training, while the frozen weights are not updated during training (e.g., the frozen weights set based on corresponding weights of the decoder-only generative model).

As a real-world example of process 500, consider a technology company that wants to develop a sophisticated encoder model capable of classifying user-uploaded images based on associated text captions (e.g., classifying a vacation photo with the caption “Fun day at the beach” into the category “Travel”). The company may start with a powerful, pre-trained multimodal decoder-only generative model that has a deep understanding of both images and text, as it was trained on vast internet-scale data. Following the process 500 of FIG. 5, the company may first generate (501) a new encoder-only model.

Next, at block 502, the weights from the attention layers of the pre-trained multimodal decoder model may be copied over to the corresponding encoder layers (e.g., Encoder Layer 1 204 through Encoder Layer N 212 in FIG. 2A) of the new model, and then may be designated as frozen weights. Designating these weights as frozen weights may preserve the nuanced, pre-existing multimodal semantic understanding of the decoder. Without freezing these weights, subsequent training on a specialized classification task could overwrite and degrade this valuable, generalized knowledge.

Finally, at block 504, the new encoder model may be trained specifically for the image-and-text classification task. As depicted in the architectures of FIG. 2A and FIG. 2B, this training focus primarily on trainable components. For instance, the system could train a new set of trainable layer weights (e.g., layer weights 1 222, layer weights 2 224, through layer weights N 226) that learn to combine the outputs from the frozen encoder layers optimally for the classification task. Additionally, a new pooling layer (e.g., pooler 218) may be added in some implementations. The pooler 218 may be trained to aggregate the token embeddings (216) into a single representative vector (pooled embedding 220) suitable for classification. As shown in FIG. 2B, this architecture may be configured to process multimodal input tokens (252) such as text (254) and vision (256) data. By freezing the core attention layers and only training the new layer weights and pooling layer, the resulting encoder model can achieve high accuracy on the specific classification task while retaining the robust, general-purpose understanding of language and imagery inherited from the original decoder model.

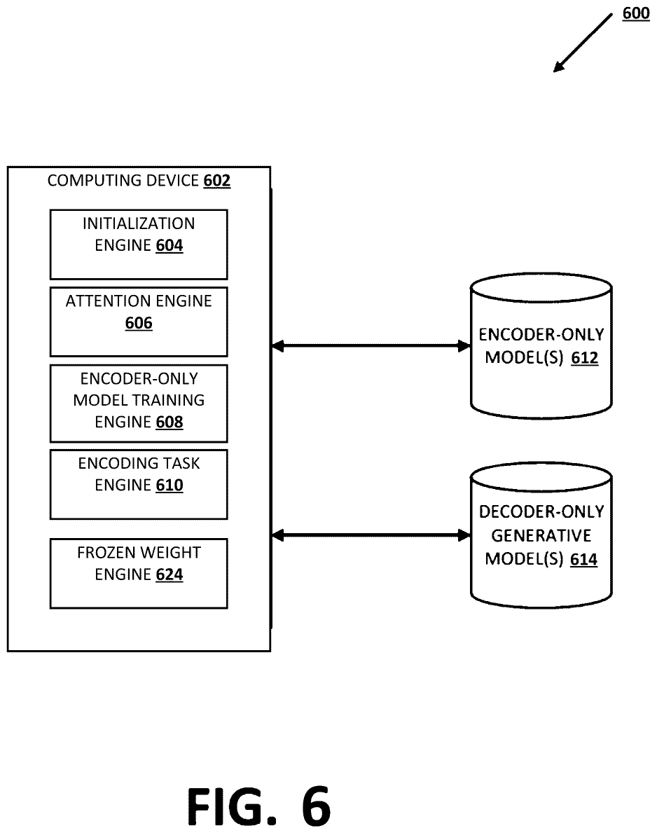

FIG. 6 is a block diagram of an example environment 600 that demonstrates various aspects of the present disclosure, and in which implementations disclosed herein can be depicted. The example environment 600 may include a computing device 602, one or more user interface input/output device(s) (not depicted), one or more additional or alternative components (not depicted), and/or combinations thereof. The computing device 602 may include one or more of initialization engine 604, attention engine 606, encoder-only model training engine, encoding task engine 610, frozen weight engine 624, one or more additional or alternative engines (not depicted), and/or combinations thereof.

Additionally or alternatively, the computing device 602 may be associated with one or more encoder-only models 612, one or more decoder-only generative models 614, one or more additional or alternative components, and/or combinations thereof. It will be understood that, in some implementations, the example environment 600 may not include one or more of the depicted elements or components. In some implementations, the example environment 600 may include one or more additional or alternative elements. In some implementations, one or more of the depicted elements may be split into two or more elements, while in other implementations, two or more of the depicted elements may be depicted as a single element (which may, e.g., at least partially share hardware/firmware/software, etc.)

In some implementations, computing device 602 and/or additional or alternative components may be communicatively coupled with each other via one or more networks, such as one or more wired or wireless local area networks (“LANs,” including Wi-Fi LANs, mesh networks, Bluetooth, near-field communication, etc.) and/or one or more or wide area networks (“WANs”, including the Internet).

In some implementations, the computing device 602 may include one or more user interface input/output devices (not depicted), which may include, for example, a physical keyboard, a touch screen (e.g., implementing a virtual keyboard or other textual input mechanisms), a microphone, a camera, a display screen, and/or speaker(s). The user interface input/output device(s) may be incorporated with one or more computing devices 602 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of computing device 602 may be implemented on a computing system that also contains the user interface input/output devices.

Some non-limiting examples of computing device 602 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Computing device 602 may include one or more memories for storage of data and software applications, one or more processors for accessing data and executing applications, and other components that facilitate communication over a network. The operations performed by computing device 602 may be distributed across multiple computing devices. For example, computing programs running on one or more computers in one or more locations can be coupled to each other through a network.

In some implementations, initialization engine 604 can initialize the weights of one or more layers of the encoder-only model 612 based on corresponding weights of corresponding layers of the decoder-only generative model 614. For example, the initialization engine 604 can initialize the weights of one or more attention layers of the encoder-only model 612 based on corresponding weights of one or more corresponding attention layers of the decoder-only generative model 614.

In some implementations, frozen weight engine 624 can set the frozen weights of one or more layers of the encoder-only model 612 based on corresponding weights of corresponding layers of the decoder-only generative model 614. For example, the frozen weight engine 624 can set the frozen weights of one or more attention layers of the encoder-only model 612 based on corresponding weights of one or more corresponding attention layers of the decoder-only generative model 614. It will be understood that, in some implementations, the frozen weight engine 624 and the initialization engine 604 may be the same as one another (e.g., sharing one or more of the same hardware/software/firmware), one may be a subset of the other, etc.

In some implementations, where the decoder-only generative model 614 includes causal attention, attention engine 606 can adapt the one or more attention layers of the encoder-only model 612 for bidirectional attention. Additionally or alternatively, encoder-only model training engine 608 can train the encoder-only model 612 for one or more encoding tasks (e.g., classification tasks, regression tasks, ranking tasks, etc.). In some implementations, encoding task engine 610 can process input using the encoder-only model 612 to generate encoding task output. The encoding task output can be used to cause one or more actions to be performed at computing device 602.

The decoder-only generative model 614 (e.g., a large language model and/or an additional or alternative generative model) described herein can be any sequence-to-sequence based machine learning model capable of generating generative vision data, generative audio data, generative textual data, and/or other forms of generative data. Some non-limiting examples of these sequence-to-sequence based machine learning models that are capable of generating one or more forms of the generative data noted above include transformer-based machine learning models (e.g., decoder-only transformer models, etc. that optionally employ an attention mechanism or some other form of memory), stable diffusion-based machine learning models, recurrent neural network-based machine learning models, generative adversarial network-based machine learning models, etc.

Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models. However, it should be noted that the generative models described herein are an example of generative machine learning models and are not intended to be limiting.

Additionally or alternatively, the decoder-only generative model can include millions or billions of weights and/or parameters that are learned through training and/or fine-tuning the generative model on enormous amounts of diverse data. This enables the decoder-only generative model to generate output based on a probability distribution over the sequence of tokens.

Although FIG. 6 is described with respect to a single computing device having a single user, it should be understood that is for the sake of example and is not meant to be limiting. For example, one or more additional client devices of a user can also implement the techniques described herein. For instance, the computing device 602, the one or more additional client devices, and/or any other computing devices of the user can form an ecosystem of devices that can employ techniques described herein. These additional client devices and/or computing devices may be in communication with the computing device 602 (e.g., over one or more network(s)). As another example, a given computing device can be utilized by multiple users in a shared setting (e.g., in a household environment, in an enterprise or work environment, in a hospitality environment, etc.).

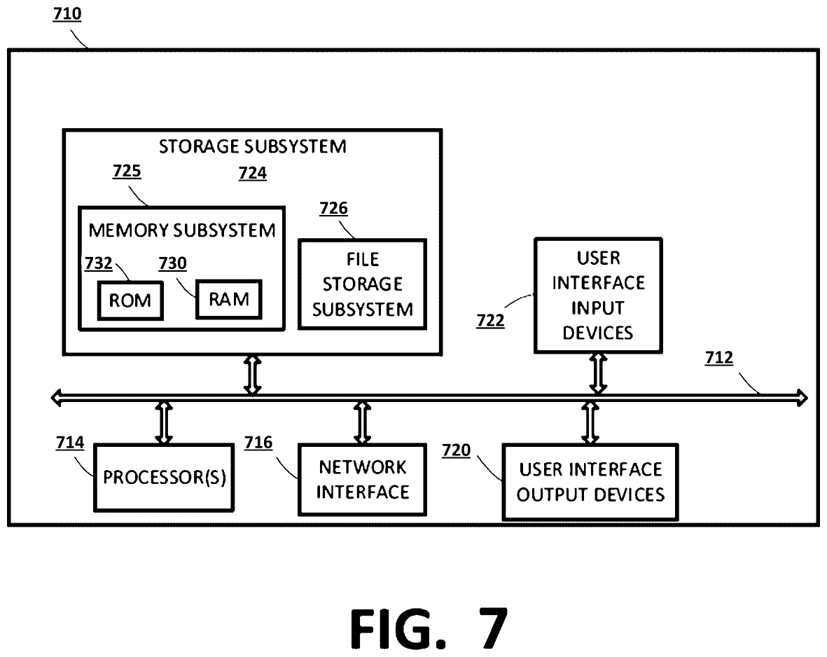

Turning now to FIG. 7, a block diagram of an example computing device 710 that may optionally be utilized to perform one or more aspects of techniques described herein is depicted. In some implementations, one or more of a client device, cloud-based automated assistant component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods such as processes 300, 400, or 500 disclosed herein, as well as to implement various components depicted in FIGS. 1A, 1B, 2A, 2B, 6, etc.

These software modules may be generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes generating an encoder-only model based on a pre-trained decoder-only generative model, wherein the pre-trained decoder-only model includes one or more attention layers that include causal attention. In some implementations, generating the encoder-only model based on the pre-trained decoder-only generative model includes initializing weights of one or more attention layers of the encoder-only model based on weights of the one or more attention layers of the decoder-only generative model. In some implementations, the method includes adapting the one or more attention layers of the encoder-only model for bidirectional attention. In some implementations, the method includes training the encoder-only model for an encoding task.

In some implementations, a method implemented by one or more processors is provided, wherein the method comprises: identifying a pre-trained decoder-only generative model that includes one or more attention layers that are configured for causal attention; initializing weights of one or more attention layers of an encoder-only generative model based on weights of the one or more attention layers of the decoder-only generative model; configuring the one or more attention layers of the encoder-only generative model to use bidirectional attention; and training the encoder-only generative model for an encoding task

In some implementations, training the encoder-only model for the encoding task includes. In some implementations, the method further includes training one or more output layers of the encoder-only model to generate encoding task output. In some implementations, the one or more output layers of the encoder-only model are upstream from the one or more attention layers of the encoder-only model that are initialized based on the pre-trained decoder-only generative model. In some versions of those implementations, the encoding task is a classification task. In some versions of those implementations, the encoding task is a regression task. In some versions of those implementations, the encoding task is a ranking task. In some versions of those implementations, training the encoder-only model for the encoding task further includes training one or more pooling layers of the encoder-only model for the encoding task, wherein the one or more pooling layers are downstream from the one or more layers initialized from the pre-trained decoder-only generative model, and wherein the one or more pooling layers are upstream from the one or more output layers.

In some versions of those implementations, the one or more pooling layers are used to perform mean pooling. In some versions of those implementations, the one or more pooling layers are used to perform attention pooling. In some versions of those implementations, the one or more pooling layers are used to perform last token pooling.

In some implementations, training the encoder-only model for an encoding task includes selecting a subset of neurons of the encoder-only model. In some versions of those implementations, the method further includes setting the weights of the subset of neurons to zero.

In some implementations, the method further includes using the trained encoder-only model in performing the encoding task.

In some implementations, initializing the weights of the one or more attention layers of the encoder-only model based on weights of the one or more attention layers of the decoder-only generative model includes for each attention layer of the one or more attention layers of the decoder-only generative model, initializing the weights of a corresponding attention layer of the encoder-only model.

In some implementations, initializing the weights of the one or more attention layers of the encoder-only model based on weights of the one or more attention layers of the decoder-only generative model, for a subset of the attention layers of the one or more attention layers of the decoder-only generative model, includes initializing the weights of a corresponding attention layer of the encoder-only model. In some versions of those implementations, at least one attention layer of the decoder-only generative model is not used to initialize the weights of at least one corresponding attention layer of the encoder-only mode.

In some implementations, training the encoder-only model for the encoding task includes updating one or more weights of the one or more attention layers of the encoder-only model.

In some implementations, training the encoder-only model for the encoding task includes freezing the weights of the one or more attention layers of the encoder-only model.

In some implementations, a method implemented by one or more processors is provided, the method includes generating an encoder-only model, where generating the encoder only model includes setting frozen weights of a set of attention layers of the encoder-only model. In some implementations, setting the frozen weights includes setting the frozen weights based on weights of a set of attention layers of a decoder-only generative model. In some implementations, the method includes training the encoder-only model for an encoding task, where training the encoder-only model for the encoding task includes training one or more trainable layer weights of the encoder-only model based on the frozen weights. In some implementations, the one or more trainable layer weights are learnable parameters indicating the strength of connections between the layers in the set of attention layers of the encoder-only model. In some implementations, the frozen weights are not trained during training of the encoder-only model.

In some implementations, a method implemented by one or more processors is provided, wherein the method comprises: identifying respective values of one or more weights of one or more attention layers of an decoder-only generative model; setting respective values of one or more weights of one or more attention layers of an encoder-only generative model based on the respective values of the one or more weights of the one or more attention layers of the decoder-only generative model; and training one or more trainable layers weights of the encoder-only generative model to generate a trained encoder-only generative model, wherein training the one or more trainable layer weights includes: maintaining respective values of the one or more weights of the one or more attention layers of the encoder-only generative model; and changing respective values of the one or more trainable layer weights; wherein the one or more trainable layers weights are learnable parameters that indicate a strength of connections between respective attention layers of the one or more attention layers.

In some implementations, each layer, in the set of attention layers of the encoder-only model, has a corresponding trainable layer weight. In some versions of those implementations, or each layer, in the set of attention layers of the encoder only-model, training the one or more trainable layer weights of the encoder-only model based on the frozen weights includes training the corresponding trainable layer weight based on processing the frozen weights of the layer.

In some versions of those implementations, training the encoder-only model for the encoding task further includes training one or more output layers of the encoder-only model to generate encoding task output. In some versions of those implementations, the one or more output layers of the encoder-only model are upstream from the set of attention layers of the encoder-only model. In some versions of those implementations, the one or more output layers are upstream from the one or trainable layer weights.

In some implementations, training the encoder-only model for the encoding task further includes training one or more pooling layers of the encoder-only model for the encoding task, where the one or more pooling layers are upstream from the set of attention layers of the encoder-only model. In some versions of those implementations, the one or more pooling layers are downstream from the one or more encoder output layers.

In some implementations, the decoder-only generative model is a pre-trained decoder-only generative model.

In some implementations, the encoding task is a classification task.

In some implementations, the encoding task is a regression task.

In some implementations, the encoding task is a ranking task.

In some implementations, the encoding task is a retrieval task.

In some implementations, the encoding task is an embedding task.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, wherein the method comprises:
identifying a pre-trained decoder-only generative model that includes one or more attention layers that are configured for causal attention;
initializing weights of one or more attention layers of an encoder-only generative model based on weights of the one or more attention layers of the decoder-only generative model;
configuring the one or more attention layers of the encoder-only generative model to use bidirectional attention; and
training the encoder-only generative model for an encoding task.

2. The method of claim 1, wherein training the encoder-only model for the encoding task comprises:
training one or more output layers of the encoder-only model to generate encoding task output,
wherein the one or more output layers of the encoder-only model are upstream from the one or more attention layers of the encoder-only model that are initialized based on the pre-trained decoder-only generative model.

3. The method of claim 1, wherein the encoding task is a classification task, a regression task, or a ranking task.

4. The method of claim 1, wherein training the encoder-only model for the encoding task further includes training one or more pooling layers of the encoder-only model for the encoding task, wherein the one or more pooling layers are downstream from the one or more layers initialized from the pre-trained decoder-only generative model, and wherein the one or more pooling layers are upstream from the one or more output layers.

5. The method of claim 1, wherein training the encoder-only model for an encoding task comprises:
selecting a subset of neurons of the encoder-only model; and
setting the weights of the subset of neurons to zero.

6. The method of claim 1, further comprising using the trained encoder-only model in performing the encoding task.

7. The method of claim 1, wherein initializing the weights of the one or more attention layers of the encoder-only model based on weights of the one or more attention layers of the decoder-only generative model comprises:
for each attention layer of the one or more attention layers of the decoder-only generative model, initializing the weights of a corresponding attention layer of the encoder-only model.

8. The method of claim 1, wherein initializing the weights of the one or more attention layers of the encoder-only model based on weights of the one or more attention layers of the decoder-only generative model comprises:
for a subset of the attention layers of the one or more attention layers of the decoder-only generative model,
initializing the weights of a corresponding attention layer of the encoder-only model,
wherein at least one attention layer of the decoder-only generative model is not used to initialize the weights of at least one corresponding attention layer of the encoder-only mode.

9. The method of claim 1, wherein training the encoder-only model for the encoding task comprises:
updating one or more weights of the one or more attention layers of the encoder-only model.

10. The method of claim 1, wherein training the encoder-only model for the encoding task comprises:
freezing the weights of the one or more attention layers of the encoder-only model.

11. A method implemented by one or more processors, wherein the method comprises:
identifying respective values of one or more weights of one or more attention layers of an decoder-only generative model;
setting respective values of one or more weights of one or more attention layers of an encoder-only generative model based on the respective values of the one or more weights of the one or more attention layers of the decoder-only generative model; and
training one or more trainable layers weights of the encoder-only generative model to generate a trained encoder-only generative model, wherein training the one or more trainable layer weights includes:
maintaining respective values of the one or more weights of the one or more attention layers of the encoder-only generative model; and
changing respective values of the one or more trainable layer weights;
wherein the one or more trainable layers weights are learnable parameters that indicate a strength of connections between respective attention layers of the one or more attention layers.

12. The method of claim 1, wherein each layer, in the set of attention layers of the encoder-only model, has a corresponding trainable layer weight, and wherein training the one or more trainable layer weights of the encoder-only model based on the frozen weights comprises:
for each layer, in the set of attention layers of the encoder only-model,
training the corresponding trainable layer weight based on processing the frozen weights of the layer.

13. The method of claim 12, wherein training the encoder-only model for the encoding task further comprises:
training one or more output layers of the encoder-only model to generate encoding task output,
wherein the one or more output layers of the encoder-only model are upstream from the set of attention layers of the encoder-only model, and wherein the one or more output layers are upstream from the one or trainable layer weights.

14. The method of claim 13, wherein training the encoder-only model for the encoding task further comprises:
training one or more pooling layers of the encoder-only model for the encoding task, wherein the one or more pooling layers are upstream from the set of attention layers of the encoder-only model, and wherein the one or more pooling layers are downstream from the one or more encoder output layers.

15. The method of claim 11, wherein the decoder-only generative model is a pre-trained decoder-only generative model.

16. The method of claim 11, wherein the encoding task is a classification task.

17. The method of claim 11, wherein the encoding task is a regression task.

18. The method of claim 11, wherein the encoding task is a ranking task.

19. The method of claim 11, wherein the encoding task is a retrieval task.

20. The method of claim 11, wherein the encoding task is an embedding task.
